(19) United States
(12) Patent Application Publication
(10) Pub. No.: US 2010/0030692 A1
(43) Pub. Date: Feb. 4, 2010

(54) METHOD FOR INSERTING ADS IN CONTENT THROUGH A PROXY

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/443,569

(22) PCT Filed: Sep. 13, 2007
(86) PCT No.: PCT/IN07/00418

§ 371 Date: Mar. 30, 2009

(30) Foreign Application Priority Data
Sep. 14, 2006 (IN) 1461/MUM/2006

(51) Int. Cl. G06Q 30/00; G06F 15/16; H04L 9/00

(52) U.S. Cl. 705/50; 709/217; 705/14.54

(57) ABSTRACT

The present invention relates generally to methods and systems for inserting advertisements and other commercial content in content and more specifically to methods and systems for inserting advertisements and other commercial content in content using a proxy and proxies thereto.

### FIELD OF INVENTION

The present invention relates generally to a method and system for inserting advertisements and other commercial content in content and more specifically to a method and system for inserting advertisements and other commercial content in content using a proxy.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram pursuant to an embodiment of the present invention.

FIG. 2 illustrates a flow diagram of a method of inserting commercial content pursuant to an embodiment of the present invention.

FIG. 3 illustrates a block diagram of the client computing system pursuant to an embodiment of the present invention.

FIG. 4 illustrates a flow diagram of a method of inserting commercial content pursuant to another embodiment of the present invention.

### DETAILED DESCRIPTION OF THE INVENTION

Before describing in detail embodiments that are in accordance with the invention, it should be observed that the embodiments reside primarily in combinations of method steps and apparatus components related to a method for inserting ads in content through a proxy. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of inserting and removing advertisements described herein. The non-processor circuits may include, but are not limited to, a radio receiver, a radio transmitter, signal drivers, clock circuits, power source circuits, and user input devices. As such, these functions may be interpreted as steps of a method for inserting ads in content through a proxy. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

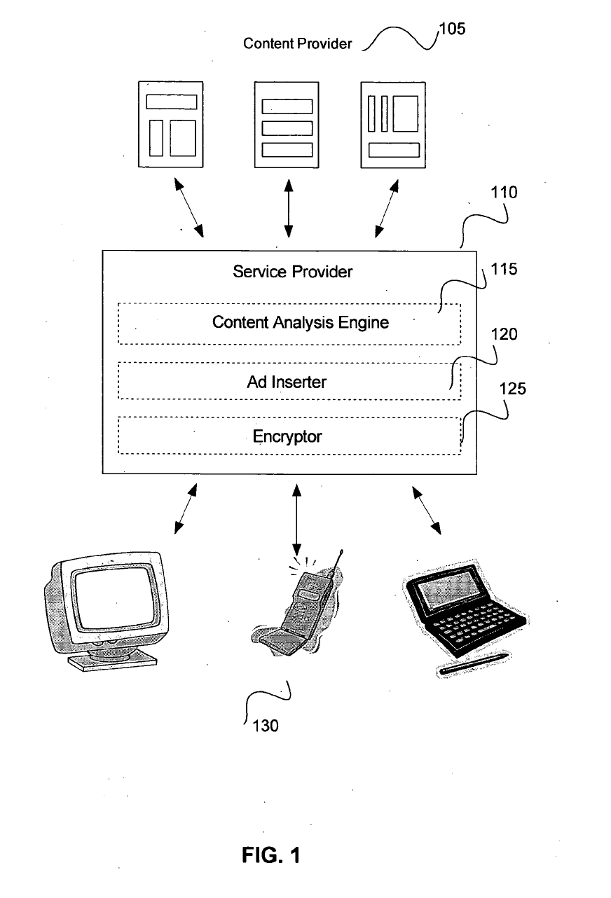

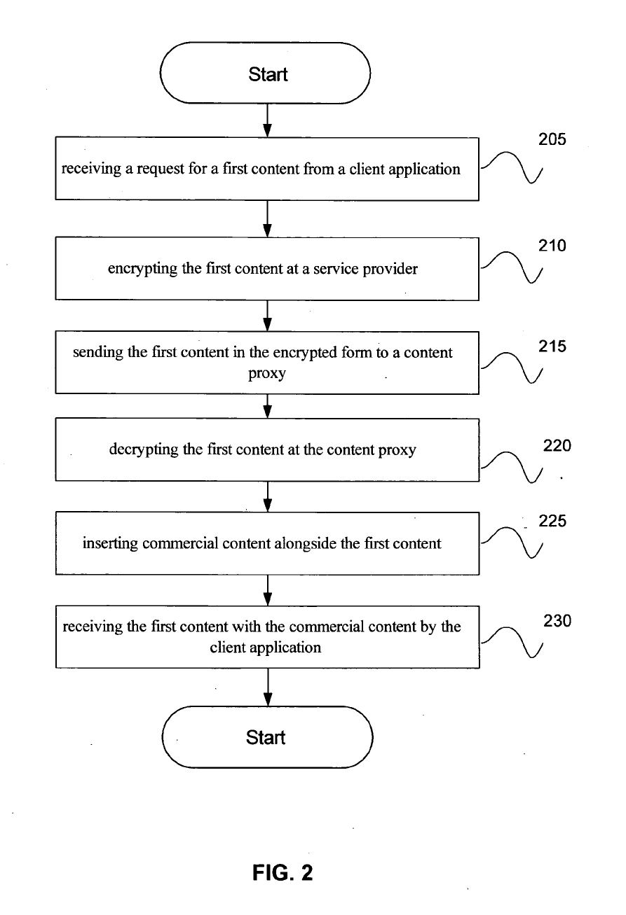

Referring now to FIG. 1 and FIG. 2, FIG. 1 illustrates a block diagram of an embodiment of the present invention and FIG. 2 illustrates a flow diagram of a method of inserting commercial content pursuant to an embodiment of the present invention. Users on the Internet access various forms of content using various client applications from content providers. The content can be content from web pages, email, or even other customized content. The content is accessed using a client application, such as a browser or an email client or any other appropriate client depending on the source of the content and the type of content. A user can access such content using a service provider by a service provider such as an Internet Service Provider (ISP). For instance, an online portal may provide information or an online email service provider may provide email which shall be content providers, while an Internet Service Provider (ISP) may actually provide connectivity to the Internet as a service for end users to view the content and hence act as a service provider. The content can be accessed via a home computer, a personal digital assistant, a laptop a mobile phone or other such device as shown in FIG. 1. Those skilled in the art shall appreciate that the service provider and the content provider may also be the same.

Generally content providers and/or service providers charge a fee to access and view the content or access the Internet. However, such content providers and/or service providers may also provide the content or service free of cost and instead earn revenue from displaying advertisements and other commercial content within the content that the user requests. The advertiser/the advertising networks such as Google or Overture parse the content of the web page and display ads relevant to the content being requested. However if the content page is behind an authenticated login interface then such advertiser networks are unable to parse the page and display advertisements. Similarly if the content is so dynamic that it changes per user, the advertisements may not always be relevant.

As per one embodiment, the service provider, such as an ISP may themselves have a content analysis engine and an ad inserter module. As per another embodiment, the content analysis engine and/or the ad inserter module may be installed in the clients computing system within a content proxy module which may be a part of the client application itself. As per another embodiment the content analysis engine and ad inserter exists both at the clients computing system as well as the service provider.

The content analysis engine analyses the content being served to the user and generates topics and keywords which can be used by the ad inserter to insert keywords, advertisements and commercial content relevant to the requested content in the header or body of the content for display along with the content.

In an alternate embodiment, the service provider may also insert tags within the content which may be replaced by ads using the ad inserter in the content proxy module at the client computing system. The content proxy module will be installed on the client computing system either as an independent program or ideally may be integrated within client applications such as email clients, chat programs, browsers or any other application that may receive content from the Internet. A request for content by the client application must be routed through this content proxy. The context analysis and ad insertion therefore may actually be done by this content proxy.

As shown in FIG. 2, a client application may request for a first content from a service provider via the Internet Service Provider (ISP). In addition to the content provider such as a website inserting commercial content, the service provider may also wish to insert additional commercial content to the user. In order to ensure that the user views the first content with the commercial content, the service provider may encrypt the first content which can only be decrypted by the content proxy prior to display of the first content with the commercial content to the user. The encryptor may apply certain algorithms such as encryption algorithms to the content which may render the content unreadable by the user unless the user's client computing system has a decryptor to decrypt this content. The decryptor shall be a part of the content proxy module so that content which is modified by the encryptor at the service provider may only be decrypted by the decryptor just prior to the user viewing the content. This prevents the user or any software on the client computing system to remove advertisements or commercial content inserted by the ad inserter before the same is displayed in the client application. In an alternate embodiment where the service provider has not inserted any commercial content but merely sent instructions to the content proxy to insert the commercial content, the commercial content can take the responsibility of inserting the commercial content either within the first content or alongside the first content and display the first content with the commercial content to the user. Those skilled in the art shall appreciate that there are several ways to encrypt or modify the content and subsequently decrypt or reverse the modifications of the content for instance, the entire content may be encrypted using an algorithm or only a portion of the content may be encrypted, in order to save processing power and all such methods of encryption are within the scope of the present invention.

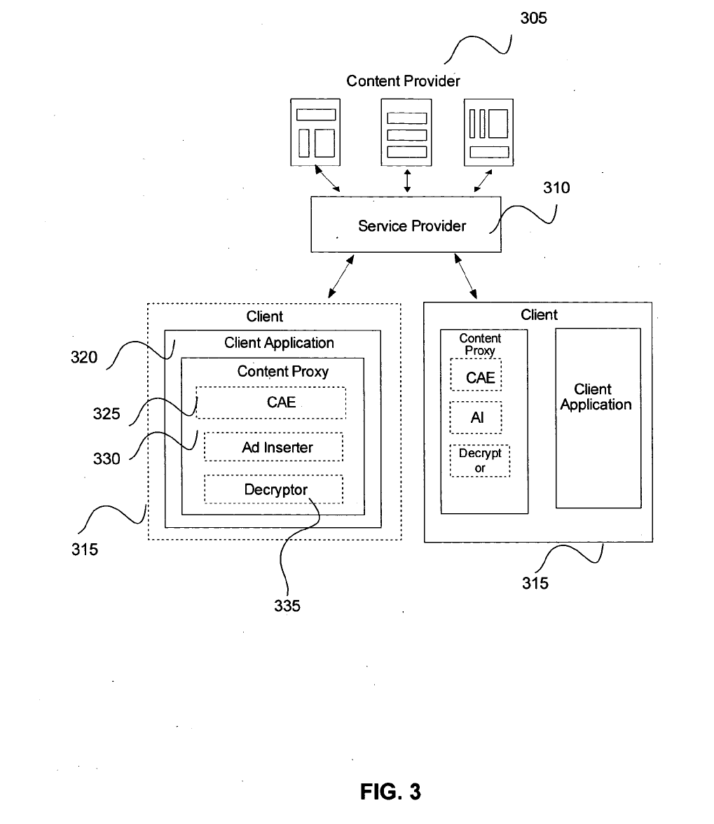

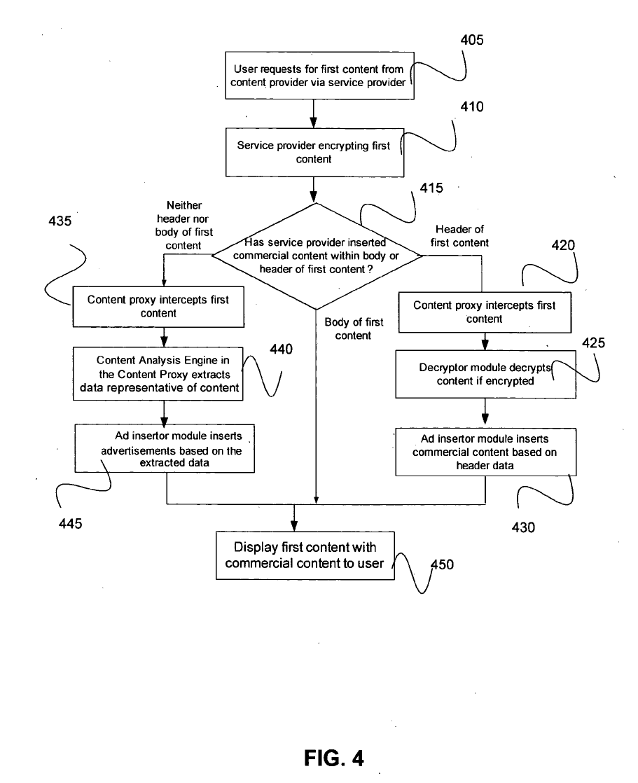

Referring now to FIG. 3 and FIG. 4, FIG. 3 illustrates a block diagram of an embodiment of the present invention and FIG. 4 illustrates a flow diagram of a method of inserting commercial content via a content proxy pursuant to another embodiment of the present invention.

When the user's client application, for example an internet browser, requests for content from a content provider via the service provider such as an ISP, the request can be sent via the content proxy. As shown in FIG. 3 the content proxy can either be a part of the client application or an independent program on the clients computing system. Generally it may be preferred when the content proxy is integrated within the client application as it may provide more certainty to the service provider that the advertisement or commercial content shall be displayed to the user without the user being able to tamper with the software to disable the display of such advertisement or commercial content.

Pursuant to one embodiment, where the service provider has already inserted the advertisements and commercial content within the body of the first content, the content proxy may directly display the first content within or alongside the client application.

Pursuant to another embodiment, the service provider may not have inserted advertisements in the first content but merely sent instructions to the content proxy in the header of the first content, in which case content proxy would insert the commercial content within or alongside the first content. For example, the service provider may not wish to enter into contracts with commercial content networks and may leave the task to a third party service provider who may control the behavior tracker and be responsible for decrypting the first content as well as displaying commercial content to the user based on the behavior information. The service provider may still encrypt the first content to ensure that the user is unable to view the first content without the content proxy having inserted the commercial content. Those skilled in the art shall appreciate that the client application may be any application on the client computing system such as a email application or a chat application or a browser etc

Pursuant to another embodiment, the service provider may not have inserted commercial content within the header or body of the first content. In this case, the content proxy shall intercept the first content analyse the first content using its content analysis engine and the ad inserter module may then insert the commercial content based on the analysis performed by the content analysis engine. The commercial content relevant the analysis can be displayed either within or alongside the first content.

Every request for the first content may or may not be sent via the content proxy but in most cases the first content must be received by the content proxy prior to display to the user. If the user tries to bypass the content proxy, the content will be unreadable due to the encryptor at the content/service provider. The advertisements and commercial content may be displayed inline within the content, or in external panels, or even using separate advertisement displayer components. Additionally, the advertisements can be fetched on a dynamic basis from an advertisement server or may be already a part of the content. For example, in the case of a chat application or an email application, the content analysis engine may analyze the content on a dynamic basis and request for advertisements from the advertisement server on a dynamic basis. In some cases, the user may frequently see the same content again. However, the advertisements can be refreshed dynamically by querying the ad server with content related keywords and user attributes to refresh the ads within the content.

In some cases, the certain applications may require the user to remove the additional advertisement and commercial content while performing certain operations. For example, if the user wishes to print the content, or wishes to forward an email to another user, an advertisement remover module installed at the client computing system may reverse the insertion of the advertisements. The ad remover module intercepts user actions which will require the ads to be removed from the content and performs the removal instructions temporarily for the duration of that particular task which requires such removal.

There are several advantages to the present invention. For example, an ISP can offer free ISP services to its subscribers by requiring all users to install a special browser or a plugin which acts as the content proxy at the client computing system. All content requested by the user can be encrypted by the ISP and the content proxy integrated within the client application or at the client computing system can be responsible for decrypting the content. During this process, advertisements can be inserted within the content either at the ISPs servers or at the client computing device as described above and displayed to the user. The ISP can earn revenue by displaying such advertisements and commercial content. Since the content will always be routed via the ISP and the content proxy, content that may be behind authenticated interfaces or secured content may also be analyzed dynamically and advertisements maybe inserted within such dynamic content.

Another example can be where a web company can offer free email services to its subscribers. The subscribers must install a custom content proxy plugin for their respective mail clients which ensures the display of ads to the users. Advertisement insertion may also be performed on content that is not directly indexable. Until now ads were published on websites that advertisement engines could index to determine the content and serve ads relevant to the content. Now with an embodiment of the present invention, the content itself passes through the content proxy, which can dynamically perform content analysis and determine appropriate topics and keywords representative of the content and insert advertisements within such content.

What is claimed is:

1. A method for inserting a commercial content within a first content, the method comprising:
receiving a request for a first content from a client application at a content provider;
sending the first content to the client application via a service provider;
inserting commercial content within the first content at the service provider;
sending the first content with the commercial content to the client application; and
displaying the first content with the commercial content by the client application.

2. The method of claim 1, wherein the inserting step further comprises:
extracting at least one of a keywords, phrases, sender attributes and recipient attributes by at least one of the content provider and the service provider; and
inserting commercial content based on the at least one of a keywords, phrases, sender attributes and recipient attributes.

3. The method of claim 1, wherein the commercial content is obtained dynamically from a commercial content provider.

4. A method for inserting a commercial content within a first content, the method comprising:
receiving a request for a first content from a client application at a content provider;
sending the first content to the client application via a service provider;
encrypting the first content at the service provider;
sending the first content in an encrypted form to the client application;
receiving the first content in an encrypted form through a content proxy installed at the client computing system;
decrypting the first content at the content proxy;
inserting commercial content within the first content at the content proxy;
sending the first content with the commercial content to a client application; and
displaying the first content with the commercial content by the client application.

5. The method of claim 4, wherein the inserting step further comprises:
extracting at least one of a keywords, phrases, sender attributes and recipient attributes, by at least one of the content provider and the service provider and the content proxy; and
obtaining commercial content based on the at least one of a keywords, phrases, sender attributes and recipient attributes.

6. The method of claim 4, wherein the commercial content is obtained dynamically from a commercial content provider.

7. The method of claim 4, wherein the content proxy is part of the client application.

8. The method of claim 4, wherein the service provider and content provider are a single provider.

9. A method for displaying commercial content with a first content, the system comprising:
receiving a request for a first content from a client application at a content provider;
sending the first content to the client application via a service provider;
encrypting the first content at the service provider;
sending the first content in an encrypted form to the client application;
receiving the first content in an encrypted form through a content proxy installed at the client computing system;
decrypting the first content by a content proxy;
displaying the first content within the client application; and
displaying commercial content alongside the first content by at least one of a content proxy or the client application.

10. The method of claim 9, wherein the commercial content is obtained dynamically from a commercial content provider.

11. The method of claim 9, wherein the content proxy is a third party software.

12. The method of claim 9, wherein the content proxy is part of the client application.

13. The method of claim 9, wherein the displaying step further comprises: displaying the commercial content within an external panel of the client application.

14. The method of claim 9, wherein the service provider and content provider are a single provider.

15. A system for inserting a commercial content within a first content, the system comprising:
a content provider for receiving a request for a first content;
a service provider for inserting commercial content within the first content received from the content provider; and
a client application for displaying the first content with the commercial content received from the service provider.

16. The system of claim 15, wherein the commercial content could be pertaining to a context of the first content based on at least one of keywords, phrases, sender attributes and recipient attributes determined from the first content.

17. A system for inserting a commercial content within a first content, the system comprising:
a content provider for receiving a request for a first content;
a service provider for encrypting the first content received from the content provider; and
a content proxy installed on a client computing system for decrypting and inserting commercial content within the first content received in an encrypted form from the service provider; and
a client application for displaying the first content with the commercial content received from the content proxy.

18. The system of claim 17, wherein the content proxy is part of the client application.

19. The system of claim 17, wherein the content proxy is an independent application.

20. The system of claim 17, wherein the content provider and the service provider can be a single provider.

21. The system of claim 17, wherein the content proxy dynamically updates the commercial content inserted within the first content.

22. A system for inserting a commercial content within a first content, the system comprising:
a content provider for receiving a request for a first content;
a service provider for encrypting the first content received from the content provider; and
a content proxy for decrypting the first content and displaying the commercial content alongside the client application, the content proxy being installed on a client computing system; and
a client application for displaying the first content received from the content proxy.

23. The system of claim 22, wherein the content proxy is part of the client application.

24. The system of claim 22, wherein the content proxy is an independent application.

25. The system of claim 22, wherein the content provider and the service provider can be a single provider.

26. The system of claim 22, wherein the content proxy dynamically updates the commercial content displayed alongside the first content.

27. A content proxy configured for:
receiving a first content in an encrypted form from a service provider;
decrypting the first content;
inserting commercial content within the first content; and
sending the first content with the commercial content to a client application for display;

28. The content proxy of claim 27, further comprises
a content analysis engine for analyzing the first content and extracting at least one of keywords, phrases, sender attributes and recipient attributes from the first content; and
an ad inserter module for inserting commercial content pertaining to the at least one of keywords, phrases, sender attributes and recipient attributes extracted from the first content.

29 The content proxy of claim 27, wherein the first content is received by the service provider from a content provider based on a request received from the client application.

30. The content proxy of claim 27 is part of the client application.

31. A content proxy configured for:
receiving a first content in an encrypted form from a service provider;
decrypting the first content;
sending the first content to the client application for display; and
displaying commercial content alongside the first content.

32. The content proxy of claim 31, further comprises
a content analysis engine for analyzing the first content and extracting at least one of keywords, phrases, sender attributes and recipient attributes from the first content; and
an ad inserter module for inserting commercial content pertaining to the at least one of keywords, phrases, sender attributes and recipient attributes extracted from the first content.

33. The content proxy of claim 31 is part of the client application.
